(19) United States
(12) Patent Application Publication
(10) Pub. No.: US 2012/0151776 A1
(43) Pub. Date: Jun. 21, 2012

(54) JACKET REMOVAL DIE AND PROCESS

(75) Inventor: JOSEPH L. DISHMAN, Statesville, NC (US)

(73) Assignee: L & P PROPERTY MANAGEMENT COMPANY, SOUTH GATE, CA (US)

(21) Appl. No.: 12/973,009

(22) Filed: Dec. 20, 2010

(51) Int. Cl. H02G 1/12; B26D 7/10; B26D 1/02

(52) U.S. Cl. 30/90.4; 30/140; 29/426.3

(57) ABSTRACT

Many types of cables require a surrounding, or jacket, around the cable. When a jacketed cable is defective, removing the jacket allows the cable and the resin that composes the jacket to be reused/recycled. A die is provided that has a narrower portion and a wider portion. An opening at the narrower portion extends internally through the die. The opening is large enough to accommodate the cable, but is not large enough to accommodate the jacket. The cutting edge of a blade is adjacent to the opening. The cable is fed through the opening at the narrower portion of the die. The jacket, being too large to be accommodated by the opening, contacts the blade and is split by the cutting edge of the blade. The jacket is spread apart by the die and peeled away from the cable.

### SUMMARY

A high-level overview of various aspects of the invention is provided here to provide an overview of the disclosure and to introduce a selection of concepts that are further described below in the detailed-description section. This summary is not intended to identify key features or essential features of the claimed subject matter, nor is it intended to be used as an aid in isolation to determine the scope of the claimed subject matter.

In a first aspect, an apparatus for removing a jacket surrounding a cable is provided. The apparatus includes a die that has an exterior surface with a narrower portion and a wider portion. An opening, which is large enough to accommodate the cable, is located at the narrower portion of the die and extends internally through the die. A blade is affixed to the exterior surface of the die such that a cutting edge of the blade is adjacent to the opening so that it cuts the jacket as the cable enters the opening.

In a second aspect, an apparatus for removing a jacket from a cable is provided. The apparatus includes a die with a conical exterior surface, an opening at the vertex of the conical exterior surface that extends through the interior of the die, a blade affixed to the conical exterior surface such that a cutting edge of the blade is adjacent to the opening at the vertex, and a heating device that is adapted to heat the die.

In a third aspect, a method for removing a surrounding from a cable is provided. A blade, next to an opening in a die, is heated. The cable is fed through the opening. A side of the surrounding is split by the blade as the cable is fed through the opening. The surrounding is spread apart at a point adjacent to the blade. The surrounding is peeled away from the cable.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts an enlarged, perspective view of an apparatus in accordance with an embodiment of the present invention;

FIG. 2 depicts a side view, similar to FIG. 1, of an apparatus in accordance with an embodiment of the present invention, shown with the heating element removed;

FIG. 3 is a view similar to FIG. 2, but showing a cable interacting with the apparatus; and

FIG. 4 depicts a system in accordance with an embodiment of the invention.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

There are many types of cables that require some type of surrounding to be applied to the cable. A surrounding may be referred to as a jacket, a coating, a sleeve, or other terms depending upon the type of cable, the type of surrounding, method of manufacture, and the intended use of the cable. Examples of cables with surroundings include an electrical wire covered with insulation, steel cables coated with a softer material to prevent damage to objects that the cable may come into contact with, and fiber-optic cables.

In the case of a fiber-optic cable assembly, a central strength member is covered by a surrounding, or jacket, and the optical fibers are wrapped around the jacket. Another covering may then be placed over the optical fibers. Optical fibers are typically packaged in a cable assembly for practical use. Some communication systems require tens or even hundreds of fibers. Packaging the fibers in a cable assembly simplifies installation and maintenance of the fibers. A cable assembly also protects the optical fibers from potentially damaging forces. Fiber optic cable assemblies generally have to be pulled into place through ducts or conduits. By exerting the pulling forces on the central strength member in the center of a fiber-optic cable assembly, the fibers are isolated from the pulling forces.

The central strength member may be made of various materials, such as steel or fiberglass, and is coated or covered (“upjacketed”) with a resin-based surrounding prior to packaging the optical fibers around the central strength member. Typical examples of the coating include polyethylene, polyvinyl chloride, and polyvinyl difluoride. Other materials may be used as well, depending on the application. The thickness of the jacket may vary depending on the application.

When a central strength member is upjacketed, the jacketed cable is sometimes defective. For example, the central strength member may not be centered within the coating, in which case the coating is thinner on one side and thicker on the other. Other examples include when the jacket has a wavy texture instead of a smooth texture, or when the jacket is inadvertently manufactured to an incorrect thickness.

When a defect occurs, it is common for the jacketed cable to be discarded, which is an expensive loss. Both the central strength member and the resin are expensive. Embodiments of the invention provide a method and device for removing a jacket from a cable, allowing the central member to be reclaimed and recoated, and the resin jacket to be reprocessed and reused.

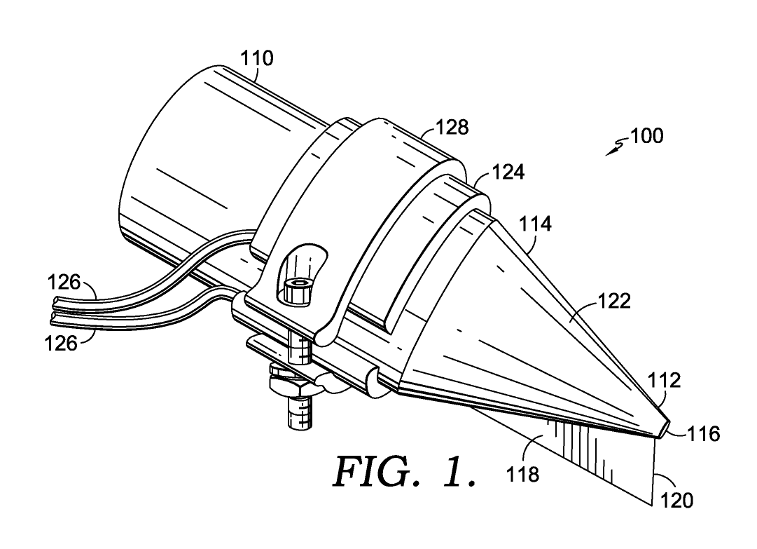

Referring now to FIG. 1, an exemplary apparatus for implementing an embodiment of the present invention is shown and designated generally as apparatus 100. Apparatus 100 is but one example of a suitable apparatus.

Apparatus 100 includes a die 110. In one embodiment, die 110 is composed of steel, which may also be hardened steel. In other embodiments, die 110 is composed of other metals or rigid materials. Die 110 includes an exterior surface 122 that has a narrower portion 112 and a wider portion 114. In one embodiment, exterior surface portion 122 is conical in shape, approximating a conical frustum or a section of a cone. In some embodiments, the wider portion 114 corresponds to the lower base of a conical frustum, while the narrower portion 112 corresponds to the upper base of a conical frustum or the vertex of a cone. In other embodiments, exterior surface 122 approximates the shape of other types of frustums. In still other embodiments, the manner of gradation from the narrower portion 112 to the wider portion 114 may define other shapes.

Die 110 includes an opening 116 at the narrower portion 112. Opening 116 extends internally through die 110. A blade 118 is affixed to exterior surface 122 of die 110. Blade 118 includes a cutting edge 120, which is adjacent to opening 116. Blade 118 is positioned such that cutting edge 120 extends away from die 110.

Apparatus 110 includes a heating device 124. Heating device 124 may be referred to as a heating band 124, a heating element 124, or other terms that describe the heating action of heating device 124. Heating device 124 includes electrical cables 126. Electrical power supplied to heating device 124 via electrical cables 126 causes heating device 124 to heat and in turn heat die 110. Blade 118 is also heated by conduction of the heat from die 110. In other embodiments, heat may be applied by way of a different configuration or type of heating device, either to die 110 or directly to blade 118.

Heating device 124 may be held in place by a clamp 128. In some embodiments heating element 124 may be affixed to die 110 by other means. In other embodiments, heating element 124 is integrated into die 110, or die 110 is configured to operate as a heating element.

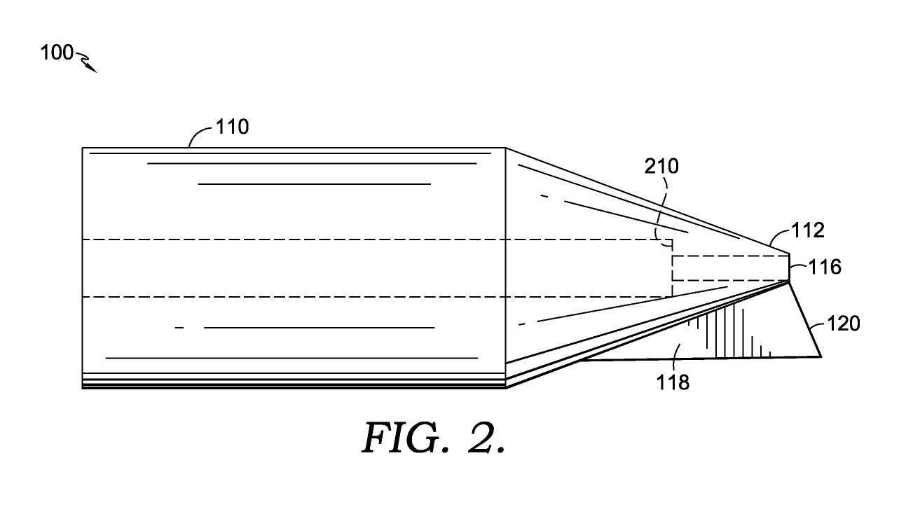

Referring now to FIG. 2, apparatus 100 is shown in a side view, but without heating element 124 for simplicity. Apparatus 100 includes die 110, narrower portion 112, opening 116, blade 118, and cutting edge 120, each of which corresponds to its respective counterpart in FIG. 1.

FIG. 2 illustrates the extension of opening 116 internally through die 110, as mentioned above with regard to FIG. 1. Opening 116 preferably widens at a location 210 internal to die 110 to provide additional clearance or room for a cable.

In one embodiment, cutting edge 120 of blade 118 slants away from die 110, as illustrated in FIG. 2. In other words, if a cable is entering opening 116 at narrower portion 112, cutting edge 120 is slanted toward the approaching cable. In an embodiment, only the portion of cutting edge 120 adjacent to opening 116 slants away from die 110.

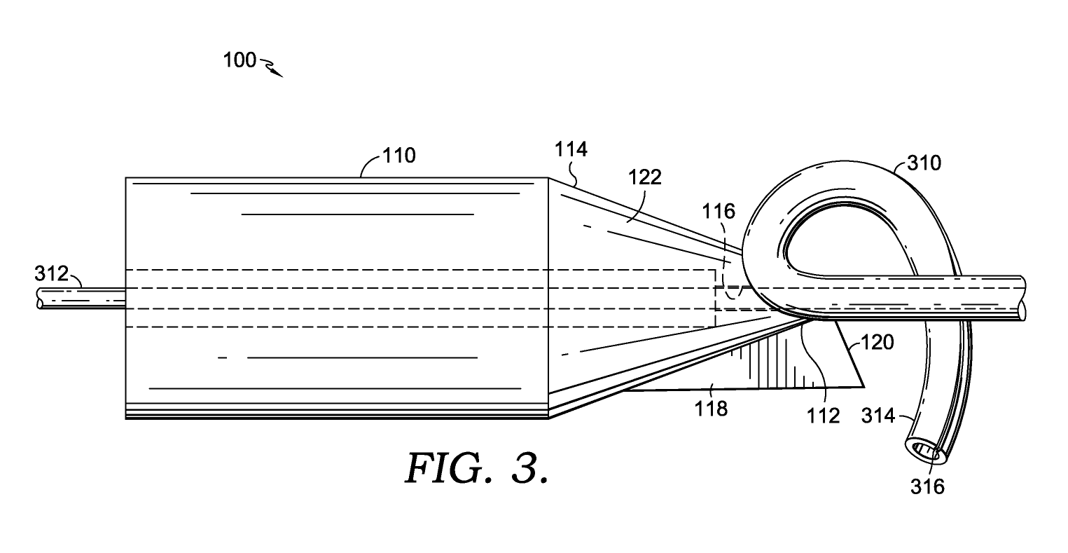

Referring now to FIG. 3, apparatus 300 is shown with a partial view of a jacketed cable 310 interacting with apparatus 100. Apparatus 100 includes die 110, narrower portion 112, wider portion 114, opening 116, blade 118, and cutting edge 120, each of which corresponds to its respective counterpart in FIG. 1.

Also depicted is jacketed cable 310. Jacketed cable 310 includes a cable 312 and a jacket 314. Opening 116 is large enough to accommodate cable 312, however, opening 116 is not large enough to accommodate jacket 314. When cable 312 is forced into opening 116 at the narrower portion of die 110, cable 312 enters opening 116 as jacket 314 comes in contact with cutting edge 120.

As cable 312 enters and passes through die 110, jacket 314 is forced onto cutting edge 120 and around the outside of the narrower portion 112 of die 110. Cutting edge 120 cuts, or splits, jacket 314 as jacket 314 moves toward die 110. A cut 316 is depicted that runs along the length of jacket 314. Heating device 124 (of FIG. 1) is not shown in FIG. 3, so as not to obscure the depiction of cable 312 passing through die 110; however, an embodiment includes heating device 124. The heating of blade 118, described above with reference to FIG. 1, increases the effectiveness of cutting edge 120 for cutting jacket 314. In an embodiment, die 110 and blade 118 are heated to approximately 171 Celsius (340 Fahrenheit). In an embodiment, a temperature that ranges between 157 Celsius (315 Fahrenheit) to 188 Celsius (370 Fahrenheit) increases the effectiveness of cutting edge 120. If the temperature is too low, cutting edge 120 may not cut jacket 314 as easily. If the temperature is too high, jacket 314 may melt and adhere to blade 118 and/or die 110. An optimal temperature for increasing the effectiveness of cutting edge 120 may vary based on the material of jacket 314.

In one embodiment, the portion of cutting edge 120 that cuts jacket 314 slants toward the approaching jacket 314, which facilitates the cutting process. As jacket 314 is forced around the outside of the narrower portion 112, it is spread apart by the exterior surface 122 adjacent to blade 118 as it moves toward the wider portion 114. Jacket 314 is thus peeled away from cable 312 as cable 312 passes through die 110. The amount of friction between cable 312 and the interior of opening 116 is reduced by the widening of opening 116 at location 210.

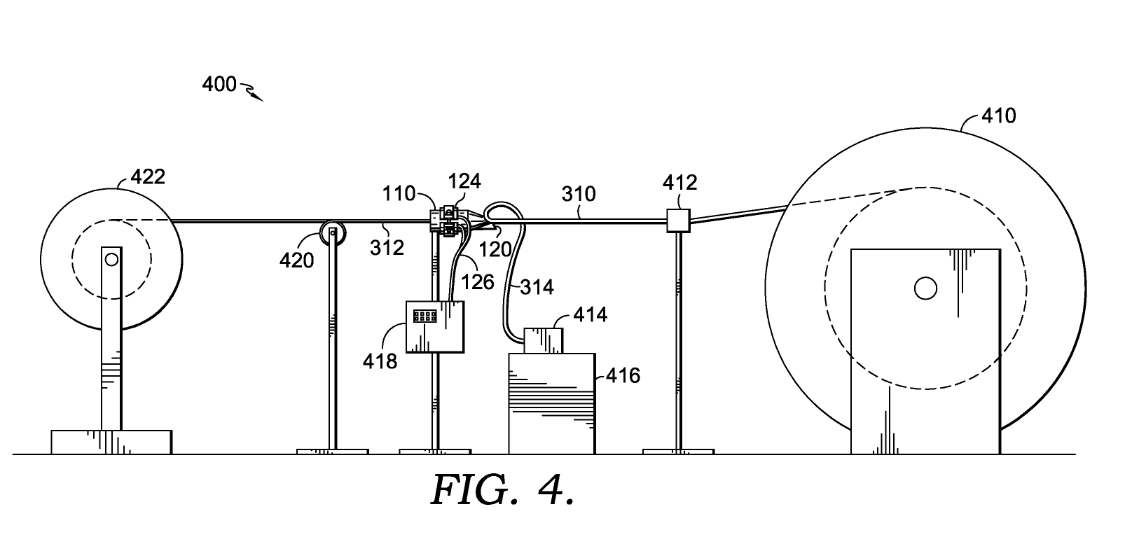

Referring now to FIG. 4, an exemplary system for implementing an embodiment of the present invention is shown and designated generally as a system 400. System 400 is but one example of a suitable system. The various components of FIG. 4 illustrate the functionality of system 400, but do not necessarily depict the actual appearance of any specific component. Nor are the components of system 400 drawn to scale.

System 400 includes die 110, heating element 124, electrical cables 126, jacketed cable 310, cable 312, and jacket 314, each of which corresponds to its respective counterpart in FIGS. 1-3. System 400 also includes a payoff reel 410, a guide 412, a grinder 414, a receptacle 416, a thermal controller 418, a capstan 420, and a takeup reel 422.

Payoff reel 410 is loaded with jacketed cable 310, from which jacket 314 is to be removed. Jacketed cable 310 passes through guide 412, which serves to stabilize the position of jacketed cable 310 as it comes off of payoff reel 410. The heating of die 110 is controlled by thermal controller 418, which is electrically connected to heating device 124 via electrical cables 126. In an embodiment, thermal controller 418 is a digital thermal controller, with a digital readout that enables a user to set the desired temperature of heating device 124. In another embodiment, thermal controller 418 is an analog device. In other embodiments, the temperature of heating element 124 and/or die 110 may be monitored and controlled manually by a user.

Initially, cable 312 is manually fed through die 110, resulting in jacket 314 being split by cutting edge 120 and peeling away from cable 312. Once enough length of cable 312 has passed through die 110, cable 312 is wrapped around capstan 420. Capstans take on many forms. In an embodiment, capstan 420 is a pulley that is driven by a motor and rotates such that it pulls cable 312 through die 110. Cable 312 is then wrapped around takeup reel 422, which collects cable 312 as it is pulled through die 110.

As jacket 314 is peeled off of cable 312, it is fed into a grinder 414. Grinder 414 is a grinder, a chopper, a shredder, or other device that renders jacket 314 into pieces having a form, size, and shape that are suitable for a reclamation process. The pieces of jacket 314 are collected in receptacle 416. Once jacket 314 is reclaimed, it can be reused to upjacket another cable.

Many different arrangements of the various components depicted, as well as components not shown, are possible without departing from the scope of the claims below. The embodiments described are intended to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. An apparatus for removing a jacket surrounding a cable, the apparatus comprising:
a die that has an exterior surface with a narrower portion and a wider portion;
an opening at the narrower portion of the die that extends internally through the die, wherein the opening is large enough to accommodate the cable; and
a blade, having a cutting edge, affixed to the exterior surface of the die, wherein the cutting edge of the blade is adjacent to the opening, and wherein the cutting edge is adapted to cut the jacket as the cable enters the opening at the narrower portion of the die.

2. The apparatus of claim 1, further comprising a heating device coupled to the apparatus that heats the blade.

3. The apparatus of claim 2, wherein the heating device heats the blade by heating the die, wherein heat is conducted from the die to the blade.

4. The apparatus of claim 1, wherein the opening is not large enough to accommodate the jacket.

5. The apparatus of claim 1, wherein a portion of the opening widens as it extends internally through the die.

6. The apparatus of claim 1, wherein an end of the cutting edge is adjacent to the opening at the narrower portion of the die and the cutting edge extends away from the die.

7. The apparatus of claim 6, wherein a section of the cutting edge that cuts the jacket slants toward the jacket that approaches the cutting edge.

8. The apparatus of claim 1, wherein a first portion of the die approximates a frustum, wherein the wider portion corresponds to the lower base of the frustum and the narrower portion corresponds to the upper base of the frustum.

9. The apparatus of claim 8, wherein the frustum is a conical frustum.

10. An apparatus for removing a jacket from a cable, the apparatus comprising:
a die that includes
(A) a conical exterior surface portion,
(B) an opening at the vertex of the conical exterior surface portion that extends through the interior of the die, and
(C) a blade, having a cutting edge, affixed to the conical exterior surface portion, wherein the cutting edge of the blade is adjacent to the opening at the vertex; and
a heating device that is adapted to heat the die.

11. The apparatus of claim 10, wherein the opening is large enough to accommodate the cable.

12. The apparatus of claim 11, wherein the opening is not large enough to accommodate the jacket.

13. The apparatus of claim 10, wherein the cutting edge of the blade is adapted to split the jacket as the cable is fed into the opening at the vertex of the conical exterior surface.

14. A method for removing a surrounding from a cable, the method comprising:
heating a blade that is adjacent to an opening in a die;
feeding the cable through the opening;
splitting a side of the surrounding with the blade as the cable is fed through the opening;
spreading the surrounding at a point adjacent to the blade; and
peeling the surrounding away from the cable.

15. The method of claim 14, wherein the die has an exterior surface with a narrower portion and a wider portion.

16. The method of claim 15, wherein the opening is located at the narrower portion of the die and extends internally through the die.

17. The method of claim 16, wherein the opening is not large enough to accommodate the surrounding.

18. The method of claim 14, wherein the blade is affixed to the exterior surface of the die.

19. The method of claim 18, wherein the blade is heated by applying heat to the die.

20. The method of claim 14, wherein the die is adapted to spread the surrounding at a point adjacent to the blade.
